(19) United States
(12) Patent Application Publication
(10) Pub. No.: US 2016/0261101 A1
(43) Pub. Date: Sep. 8, 2016

(54) Replacement screw guide

(71) Applicant: Michael Fred Hopper, Woodinville, WA (US)

(72) Inventor: Michael Fred Hopper, Woodinville, WA (US)

(21) Appl. No.: 14/757,120

(22) Filed: Nov. 19, 2015

Related U.S. Application Data
(60) Provisional application No. 62/082,114, filed on Nov. 19, 2014.

(51) Int. Cl. H02G 3/14; H02G 3/18; H02G 3/08

(52) U.S. Cl. CPC H02G 3/14; H02G 3/081; H02G 3/18

(57) ABSTRACT

Described herein there is a device for securing a screw to a junction box, the device having a plate having an aperture for engaging a screw, the plate sized to align the aperture with a screw receptacle of a junction box, and at least one fastener for engaging the junction box and holding the replacement screw guide in substantially the proper position and alignment with respect to the screw receptacle.

### CROSS REFERENCE

This case claims priority from US Provisional Application 62/082,114, filed on Nov. 19, 2014 the contents of which are herein incorporated by reference in their entirety.

### BACKGROUND

Junction boxes are generally used as receptacles for sockets and other electrical or signal carrying components, and form a protected volume for which various components may be secured. Often junction boxes are used behind walls in homes and buildings for electrical outlets, light switches and communication relay ports (like cable outlets, phone jacks or computer network outlets). Junction boxes may be made of plastic, metal or other materials. Junction boxes generally have screw receptacles at fixed positions designed to receive screws or other fasteners and allow sockets to be secured within the junction box. To prevent exposed wires and increase aesthetic appeal, junction boxes are generally covered with a face plate.

In building and home construction or improvement, sockets and other electrical components may be replaced inside the junction box. The removal of old equipment and insertion of new equipment sometimes leads to the guide screws for the sockets to become stripped. When this happens a replacement screw guide may be used, or the junction box itself may be replaced. Replacement of a junction box can require specialized labor and disproportionate expense relative to the cost of the part being replaced. Replacement screw guides currently on the market tend to be difficult to place and do not form natural alignment with the stripped screw receptacle they are intended to replace.

### SUMMARY

Described herein are various embodiments of a device or apparatus to operate principally as a replacement screw guide for use with a junction box. Junction boxes for both standard electrical and low voltage use generally have screw holes for receiving screws. Generally the screws are used to attach an internal component intended to fit inside the junction box, such as one or more electrical socket(s), light switch(s), or other adapter (such as RJ-11, Coax and/or cat5/6 jack) to the junction box. The combination of the junction box and the internal component of the junction box are herein referred to as the junction box assembly.

In an embodiment, there is an apparatus for securing a screw to a junction box, the apparatus comprising a plate having an aperture for engaging a screw, the plate sized to align the aperture with a screw receptacle of a junction box, and at least one fastener for engaging the junction box and holding the replacement screw guide in substantially the proper position and alignment with respect to the screw receptacle.

In some embodiments the plate has a plurality of apertures for engaging a plurality of screws, the plate substantially adapted to frame at least a portion of an opening of a junction box.

In some embodiments the plate is adapted to substantially frame the whole of a junction box opening.

In some embodiments the fastener is releasable.

In some embodiments the replacement screw guide may be attached to a junction box and concealed under a face plate.

In an embodiment, there is a plate having a hole. The hole may be appropriately sized so that a screw may be threaded through it. The type of screw is not material so long as the hole is adapted for the screw to engage the hole (screwing through the hole) rather than sliding through the hole without rotating. The plate can be arranged to generally be perpendicular to the side walls of the junction box. The hole in the plate can be positioned so as to align with a screw hole in a junction box. The plate may include a fastener for attaching to the junction box. The fastener may include a face plate that can take the place of the plate having a hole. The fastener may be a single fastener for a single point or area of contact on the junction box, or it may be more than one fastener, such as a pair of fasteners on each side of the screw hole that needs to be replaced. The plate may be dimensioned to minimize its bulk in relation to the junction box and a cover plate, so that a cover plate may be used to cover the junction box without the plate causing uneven attachment of the face plate to the junction box, or without the replacement screw guide being visible once the face plate is properly attached to the junction box assembly.

Alternatively the hole may be unthreaded and adapted to receive a screw or other fastener capable of engaging a portion of the damaged screw receptacle of the junction box. The fastener may have a tapered section or a secondary feature to engage the hole when inserted through the hole to a sufficient depth. In still another embodiment, the replacement screw guide may for a lock and key type assembly with a fastener used to secure a component into the junction box, where the component engages the replacement screw guide, and the replacement screw guide engages the junction box.

In various embodiments, the replacement screw guide may be made of metal. In other embodiments the screw guide may be made of hard plastic or other polymer material. The plate element may be made of a separate material from the fastener. In an embodiment the plate and fastener are made of the same material and the replacement screw guide is formed from a single piece of material (either as a cut out or stamped product). Alternatively the replacement screw guide may be formed from several pieces of material and assembled together using fasteners, welding, glue or mechanical interference.

In another embodiment, there is a frame plate generally shaped to match the rim of a junction box. The frame forms a plate generally perpendicular to the side walls of the junction box, and can be adapted to fit over the junction box. The frame plate may have a hole for guiding a screw in sufficient quantity and position so as to match the number of screw holes in the junction box. The frame plate may have one or more fasteners adapted to engage the junction box.

In another embodiment, a frame plate may be shaped to generally fit over the edge of a junction box and have one or more holes adapted to receive a screw for engaging in a screw like fashion through each hole. The frame plate may have a configuration to guide two or more screws into a junction box, but less than the total number of screws the junction box is capable of receiving.

The foregoing summary is illustrative only and is not intended to be in any way limiting. In addition to the illustrative aspects, embodiments and features described above, further aspects, embodiments and features will become apparent by referring to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. It should be understood that these drawings depict only several embodiments in accordance with the disclosure and are, therefore, not to be considered limiting in scope. The disclosure will be described with additional specificity and detail through use of the accompanying drawings, in which:

FIG. 1A-D are diagrams illustrating various views of an embodiment of a RSG;

FIG. 2 is a diagram illustrating an assembly view of a RSG and a junction box;

FIG. 3A-B are diagrams illustrating a profile view of a RSG attaching to the edge of a junction box;

FIG. 4A-B are diagrams illustrating a frame type RSG;

FIG. 4C-D are diagrams illustrating an assembly view of a frame type RSG;

FIG. 5A is a diagram illustrating an assembly illustration of a frame RSG with an electric socket;

FIG. 5B-C are diagrams illustrating assembled views of a RSG with various electric components;

FIG. 6A is a diagram illustrating an assembly drawing of a junction box contents and face plate;

FIG. 6B is a diagram illustrating an assembled junction box and face plate cover;

FIG. 7 is a diagram illustrating an alternate face plate for use with a junction box.

### DETAILED DESCRIPTION

Generally presented herein are various embodiments of a guide used to properly align an elongate fastener (collectively referred to herein as a “screw” or “screws”), such as a nail, screw, pin, dowel or similar elements, into a damaged or otherwise unusable screw receptacle of a junction box. The replacement guide may be shaped and/or sized for any variety of screw like consumables, for either metric or imperial sized screws. It may also be shaped and adapted for use in any national standard form for junction boxes, custom sized or shaped junction boxes and their respective face plates. The shape of the junction box the screw guide is fitted to is not critical as embodiments are presented herein adapted to work with any shape junction box. Upon review of the present description and the accompanying drawings and claims, persons skilled in the art shall appreciate a multitude of applications for the designs presented herein. All such embodiments described herein and those which may become equivalents are herein contemplated and covered under the description and appended claims.

In an embodiment, there is a screw guide having a hole or aperture set in a plate. The plate may have one or more attachment means for connecting the plate to a junction box. The guide may be used to align a screw into a screw receptacle or socket. The screw socket of the junction box being ordinarily designed or intended to receive a screw to secure whatever contents the junction box is designed to hold. Such contents may include, but are not limited to, a socket, a power switch, a low voltage receptacle such as a local area network (LAN) receptacle, a cable receptacle (co-ax) and/or a phone jack (RJ-11). Additional devices may be set into the junction box, such as a motion sensor, a wireless receiver, a light sensor, or anything shaped to be held at least partially into a junction box, or at least partly secure to the junction box (collectively anything to be secured within or about the junction box is referred to herein as an electrical component). It is not necessary that the securing be done into the screw receptacles of the junction box, so long as the electrical component is secured to the replacement screw guide (RSG) and the RSG is secured to the junction box. In various embodiments the replacement screw guide may be configured so that it is not visible when a face plate is placed over the junction box. The replacement screw guide may have a foot print which matches the coverage are of a face plate, or have a foot print less than the area covered by a face plate. In some embodiments, the RSG may have a foot print greater than the face plate. Non-limiting examples include instances to promote specific functions (e.g. waterproofing the junction box) or decorative functions.

In an embodiment, there is a hole or aperture set into a plate. The hole may he threaded so as to permit a threaded screw to engage the hole and help secure one or more electric component(s) into the junction box. The hole (or aperture) may be sized to receive a specific diameter screw and have threads for an actual screw, or may be a simple hole used to guide a screw into the damaged junction box screw receptacle. The hole may be larger than the screw used to set the electric component so long as the hole is sufficient to guide the screw into the screw receptacle. The plate may be attached to one or more clips for attaching the plate to a junction box. The clips or other attachment mechanism(s) may be positioned to fasten the plate to the exterior wall of the junction box, or some other feature so as the replacement screw guide has the hole aligned with the screw receptacle of the junction box. The clips may provide removable attachment to the junction box, in case the replacement screw guide needs to be removed, recovered or repositioned. The plane of the plate may be positioned to be substantially close to perpendicular the axis of the screw receptacle of the junction box. Deviations in alignment are permitted as long as the RSG can guide a screw into the screw receptacle of the junction box. In some embodiments, the alignment deviation may be +/−15 degrees. In other embodiments the hole of the RSG maybe +45 degrees such that the RSG forms a hypotenuse to the angle of the plane of the opening of the junction box. Any angle of alignment from 0 to +45 degrees is considered herein as substantially the proper position and alignment with respect to the screw receptacle. In some cases the plate may be beyond the substantial alignment ranges and still operate. The plate may have one or more stress relief slots in order for the hole to twist or torque in a way so that the screw may still light up with the screw receptacle of the junction box.

In various embodiments, the RSG may be used to properly place a single screw into a single damaged screw receptacle. In other embodiments, the RSG may have more than one hole so as to fit over more than one screw receptacle. In still other embodiments, the RSG may have multiple holes to guide to multiple screw receptacles, but a user may remove any unwanted holes and rely on the junction boxes native screw receptacles. In some embodiments there may be a single plate with a single hole adapted to fit into a single localized portion of a junction box. In other embodiments the RSG may have a frame generally matching the perimeter of a junction box. In a frame embodiment there may be a RSG hole over every native screw receptacle of the junction box. In still other embodiments, there are any variation between a single RSG and one covering every screw receptacle, with the various number of RSG holes arranged in any fashion, pattern or relationship to each other, that a user or manufacturer may desire. In still other embodiments, the RSG may have one or more hole(s) to match the screw receptacles of the junction box in some location(s) and not in other(s). The RSG in any embodiment may be adapted to fit over any junction box perimeter shape, such as a round junction box, square or rectangle. The junction box may have generally straight side walls or curved. The position of attachment for the RSG to the junction box may be along a generally uninterrupted wall surface, or a corner where two or more sidewalls meet or intersect.

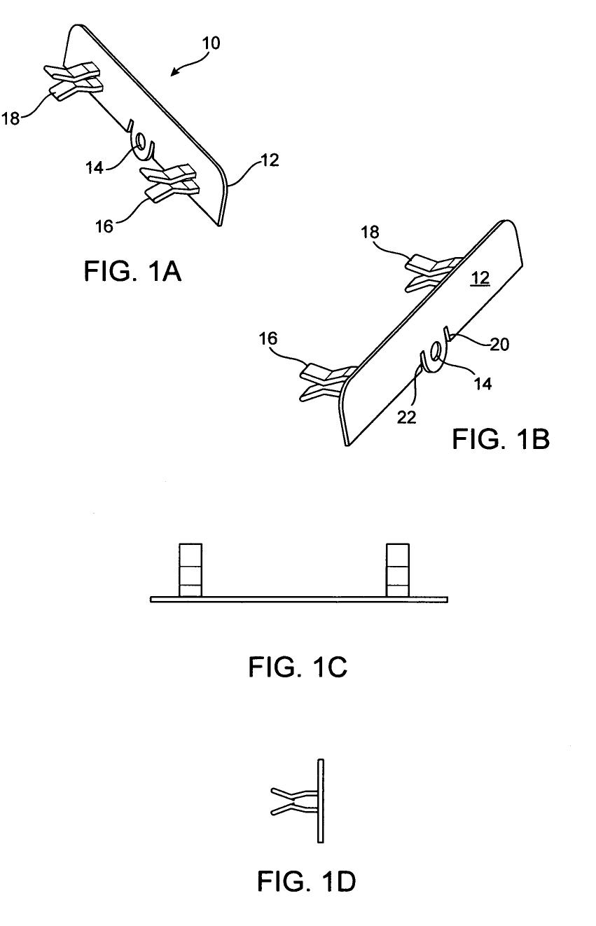

Turning now to the drawings, an embodiment of a replacement screw guide 10 (RSG) is shown having a plate 12 and one or more clips 16, 18 for attachment to a junction box side wall (FIG. 1). The RSG 10 has a guide hole 14. In some embodiments the RSG 10 may also have one or more stress relief slots 20, 22 to allow the plate section with the hole 14 to flex some when a screw 204 is inserted through the hole. The hole or aperture 14 may be threaded to receive a screw 204 able to engage the hole 14 and also fit inside the damaged screw receptacle of the junction box. Alternatively the screw used to engaged the hole 14 may be of a larger diameter than the junction box screw receptacle, but shortened lengthwise so as to only engage the hole 14 of the RSG 10, and not actually engage the screw receptacle of the junction box. Alternatively the hole 14 may be unthreaded to allow a screw to simply slide through the hole 14 and enter the screw receptacle 206 of the junction box 208. The hole 14 may be sized to receive a particular gauge screw designed for the screw receptacle or may be slightly larger or smaller in bore diameter to allow a correspondingly larger or smaller screw to be threaded through it. In another embodiment the hole 14 may be lined with a polymer allowing a screw to “catch” the polymer while moving through the hole 14 to engage the screw receptacle 206. The polymer may be sufficiently soft to yield to the screw and provide a matching thread to the screw 204 while at the same time firm enough to maintain a guide sight for the screw.

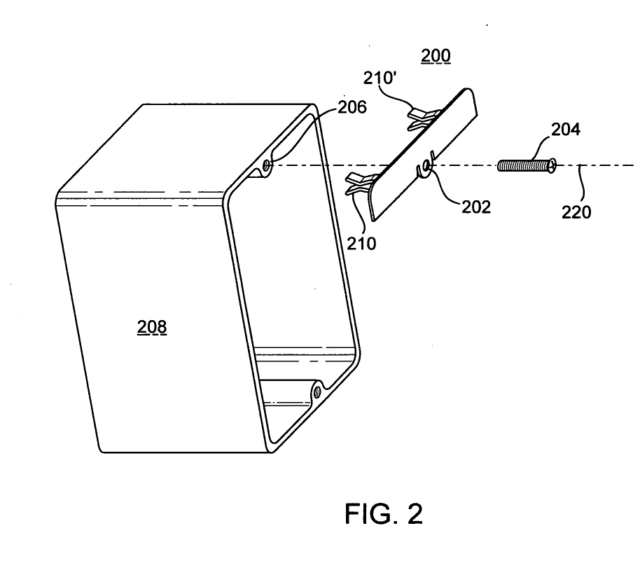

In various embodiments, there maybe one or more clips 210, 210′ (FIG. 2) used to attach the RSG 10 to the junction box 208. While clips are shown, any attachment device may be used to connect the RSG to the junction box. It is not critical that the connection clip be attached to the RSG, the clip may be a separate device to attach the RSG to the junction box.

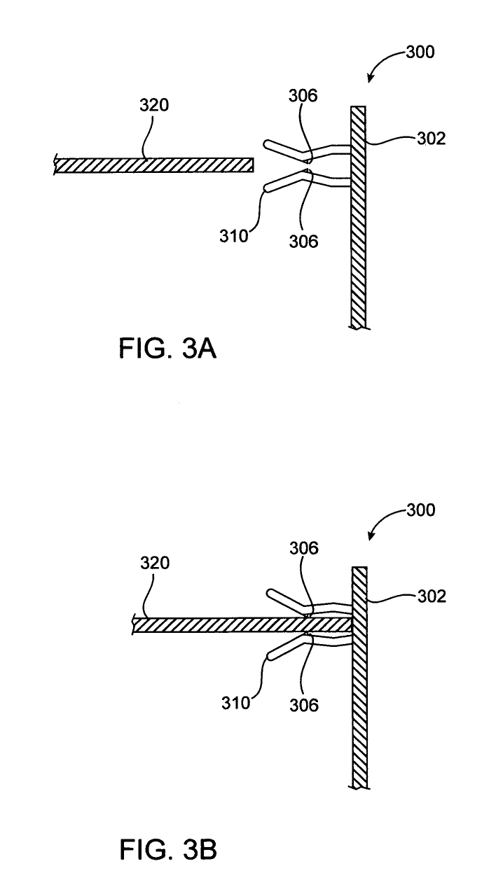

In an embodiment, the RSG 300 can be pushed so that a clip 310 will engage both sides of a junction box side wall 320 (FIG. 3A-B). The clip 310 may optionally have one or more teeth 306 for engaging the side wall 320 of a junction box. The RSG 300 may be advanced sufficiently to make physical contact with the junction box side wall if desired, however this engagement is not necessary.

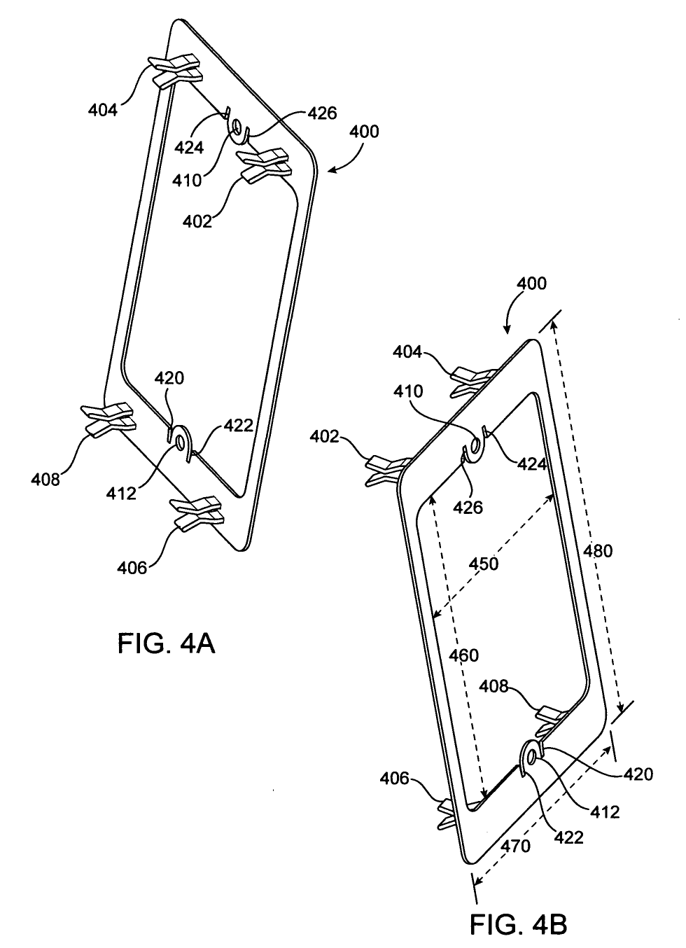

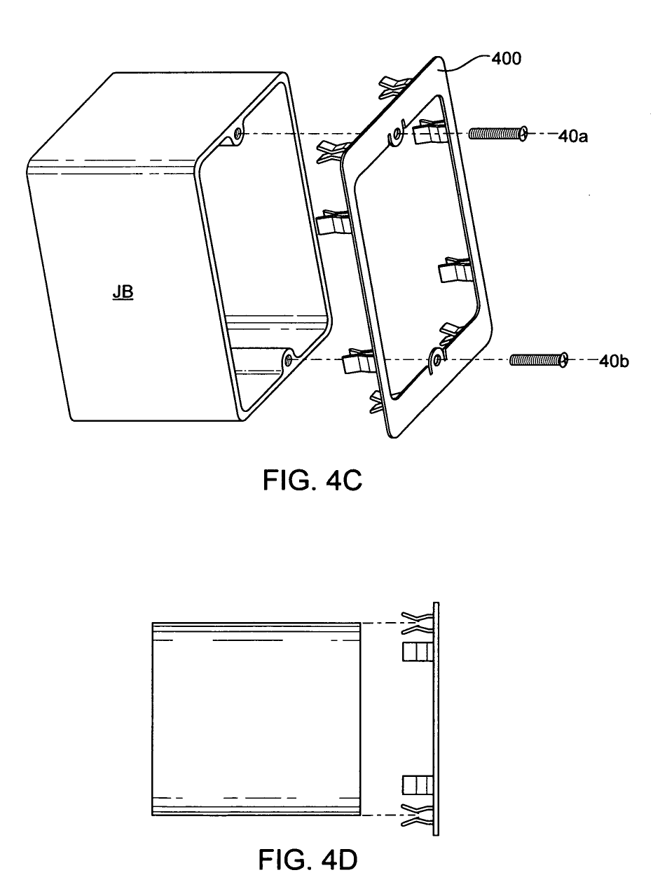

In another embodiment, the RSG 400 may take the form of a frame that generally matches the perimeter of a junction box (FIG. 4A-B). In some embodiments, the RSG 400 has a foot print that does not exceed the coverage provided by a face plate that may be used to cover the junction box. In some embodiments the RSG 400 may have a foot print that exceeds the coverage provided by a face plate. In embodiments where the RSG 400 foot print exceeds that of a potential cover plate, the RSG 400 may have a decorative fringe to help improve the aesthetic appearance of the RSG 400 that is not covered by a face plate. In embodiments where the RSG 400 may have a frame shaped to generally match that of a junction box, the RSG may have one or more openings through which an electrical component may be recessed. The RSG 400 frame opening may have a first interior dimension 450 and a second interior dimension 460. The RSG may also have a first external dimension 470 and a second external dimension 480.

The RSG 400 may have any number of clips arranged on either the horizontal or vertical sides of the RSG 400. There may be four clips 402, 404, 406, 408, or there may be as few as one (such as along clip along one side) or many clips (such as many small prongs used to simply guide the orientation of the RSG into the junction box. Placement of one or more screws through holes 410, 412 may be used to secure the RSG in place so long as the junction box screw receptacles arc able to guide the screw. The junction box screw receptacles may be ‘stripped’ and unable to catch the screw. In such cases more robust binding “clips” may be used to hold the RSG 400 in place. The RSG in a frame like configuration may have stress relief slots 420, 422, 424, 426 near the screw guide holes 410, 412. Again, the interior orientation of the clips and stress relief slots is not critical to the operation of the RSG 400, and various designs may or may not need the use of stress relief slots.

An assembly drawing is shown in FIG. 4C providing the RSG 400 and the junction box JB lacking proper screw receptacles. One or more clips may be used to secure the RSG to the junction box face. Screws 40a, 40h are shown for reference only. Generally the screws are not put into the RSG absent an electrical component. A profile view of an RSG and a junction box is provided in FIG. 4D.

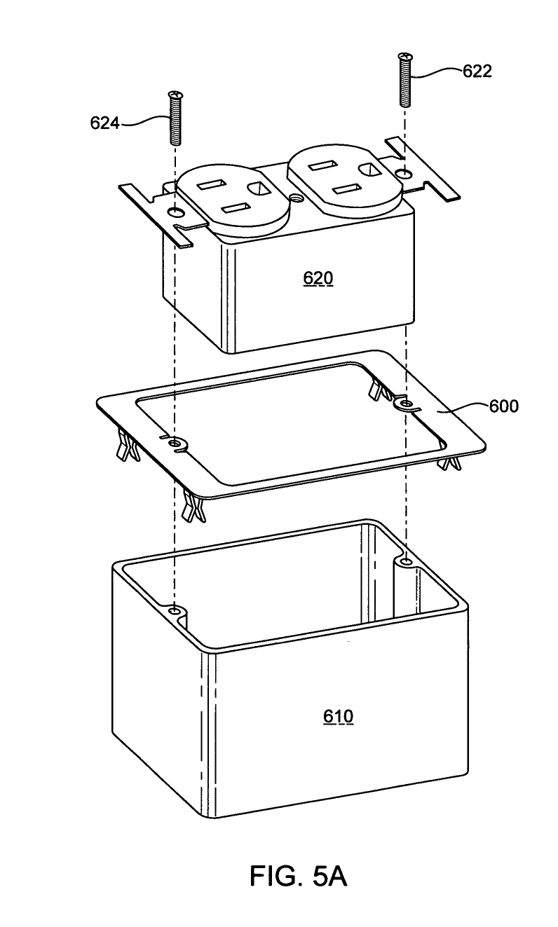

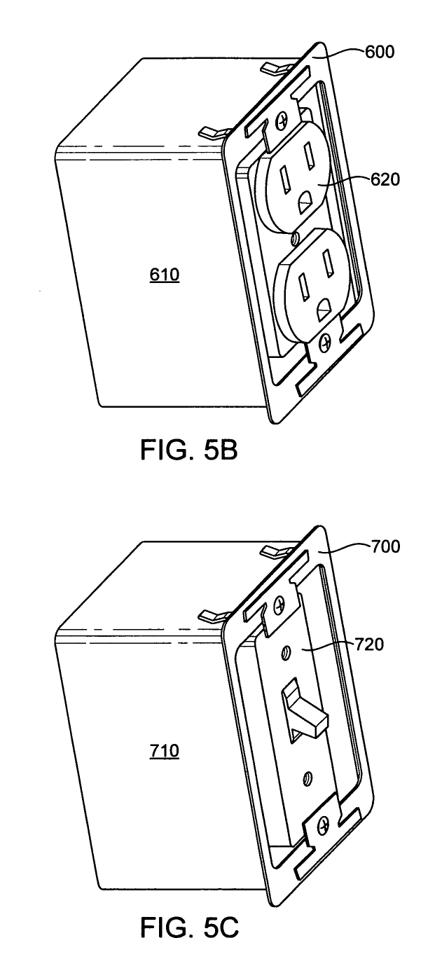

In an embodiment, there is an electrical component 620, such as a socket, switch or low voltage device to be secured within a junction box 610 (FIG. 5A). The junction box may have stripped out screw receptacles, or a user may simply want additional guides for positioning screws. The RSG 600 is placed in proper alignment over the junction box 610 so the screw holes of the RSG are lined up with the screw receptacles of the junction box. An electrical component 620 is then placed over the RSG so the screw holes of the electrical component, and the screw holes of the RSG are in line with the screw receptacles of the junction box. Screws 622, 624 can then be used to secure the ensemble together.

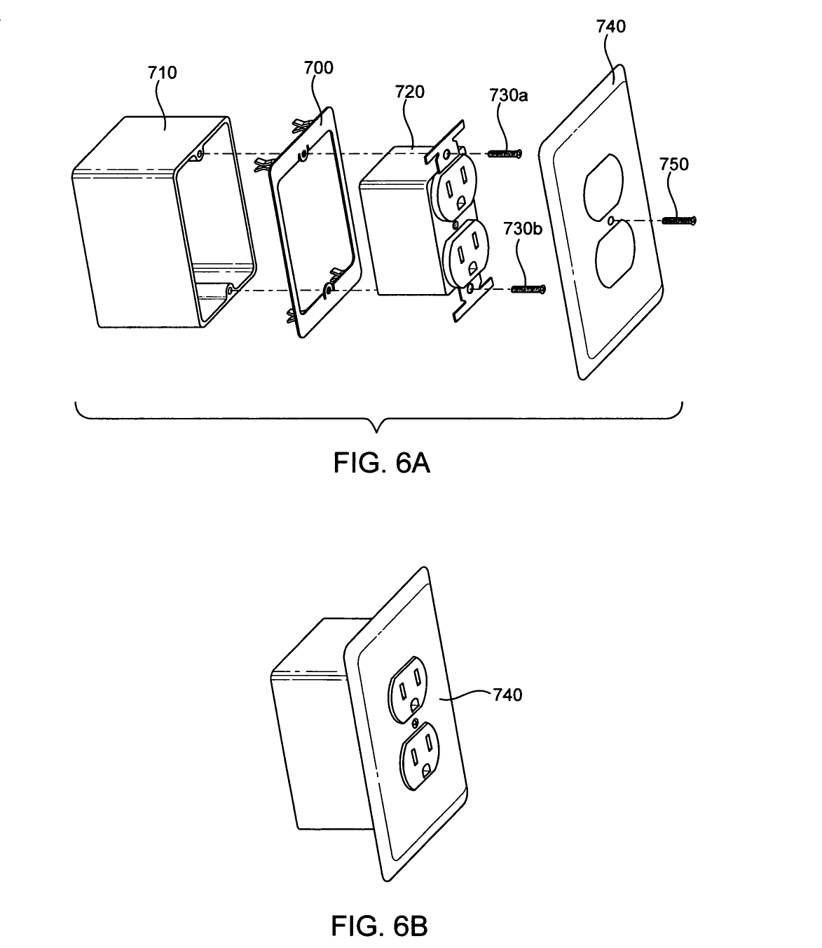

In an embodiment, the replacement screw guide fits between the junction box 610 and the electrical component 620. The completed assembly of a frame style RSG is shown now in FIG. 5B. Various non-limiting embodiments are depicted in FIG. 6B (two stack electrical socket) and FIG. 5C (electrical switch).

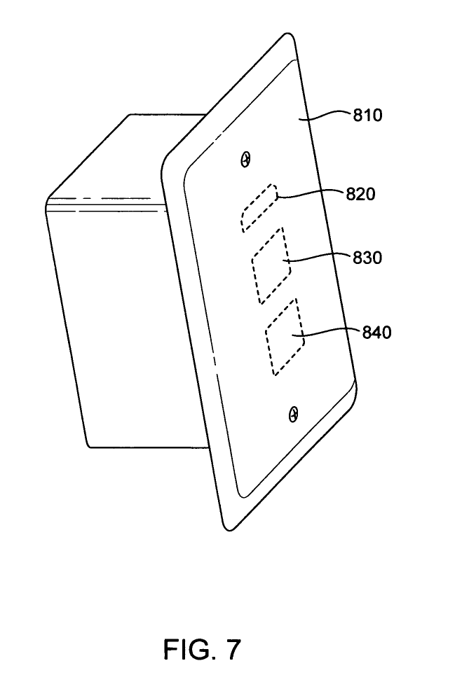

FIG. 6A provides an assembly view in which a junction box 710 is combined with a RSG 700. An electrical component 720 is fitted to the RSG 700 and secured to the junction box 710 via a pair of screws 730a, 730b. A face plate 740 is secured to the electrical component normally with screw 750. The completed assembly is shown in FIG. 6B. An alternative embodiment showing a face plate and dashed line of a low voltage electrical component is shown in FIG. 7.

The foregoing detailed description should not be considered as exclusive or limiting the scope and breadth of the subject matter described herein. Persons skilled in the art upon reviewing the present disclosure will appreciate a wide range of equivalent embodiments are possible without deviating from the spirit and scope of the description provided or the appended claims. All such equivalents are herein contemplated and intended to be covered by the description provided and the appended claims.

1. An apparatus for securing a screw to a junction box, the apparatus comprising:
a plate having an aperture for engaging a screw, the plate sized to align the aperture with a screw receptacle of a junction box, and
at least one fastener for engaging the junction box and holding the replacement screw guide in substantially the proper position and alignment with respect to the screw receptacle.

2. The apparatus of claim 1 wherein the plate has a plurality of apertures for engaging a plurality of screws, the plate substantially adapted to frame at least a portion of an opening of a junction box.

3. The apparatus of claim 2, wherein the plate is adapted to substantially frame the whole of a junction box opening.

4. The apparatus of claim 1, wherein the fastener is releasable.

5. The apparatus of claim 1 wherein the replacement screw guide may be attached to a junction box and concealed under a face plate.
